(19) United States
(12) Patent Application Publication
(10) Pub. No.: US 2025/0108701 A1
(43) Pub. Date: Apr. 3, 2025

(54) METHOD FOR REDUCING BACKLASH IN A VEHICLE AND CONTROL ARRANGENT CONFIGURED TO PERFORM THE METHOD

(71) Applicant: Scania CV AB, Södertälje (SE)

(72) Inventors: Daniel Ståhl, Enköping (SE); Magnus Carlgren, Vagnhärad (SE); Martin Berglund, Vagnhärad (SE); Mattias Hedberg, Handen (SE)

(73) Assignee: Scania CV AB, Södertälje (SE)

(21) Appl. No.: 18/895,609

(22) Filed: Sep. 25, 2024

(30) Foreign Application Priority Data
Oct. 3, 2023 (SE) 2351136-3

(51) Int. Cl. B60L 15/32

(52) U.S. Cl. CPC B60L 15/32; B60L 2200/28

(57) ABSTRACT

Control arrangement and method for reducing backlash in a vehicle, said vehicle comprising a first powertrain configured to provide propulsion torque to one or more first drive wheels of the vehicle, and a second powertrain configured to provide propulsion torque to one or more second drive wheels of the vehicle, wherein the first and second powertrains are mechanically separated from each other. The method comprises, when a requested net torque for the vehicle is within the deliverable torque of one of the first powertrain and the second powertrain, controlling the first powertrain to deliver a first torque to said one or more first drive wheels and the second powertrain to deliver a second torque to said one or more second drive wheels, the first torque and the second torque having opposite torque directions.

### TECHNICAL FIELD

The present disclosure relates in general to a method for reducing backlash in vehicle. The present disclosure further relates to a control arrangement configured to reduce backlash in a vehicle.

Moreover, the present disclosure relates in general to a computer program and a computer-readable medium. The present disclosure also relates in general to a vehicle.

### BACKGROUND

Motorized vehicles comprise at least one power source configured to provide propulsion torque to one or more drive wheels of the vehicle via a driveline. The driveline and the power source (or power sources) connected thereto together form a powertrain of the vehicle. The driveline usually comprises several different elements or units, including for example one or more transmission units, various shafts, and/or a differential, which in turn may comprise various components. Various interacting constituent components of the driveline may often comprise a play (also known as a gap or clearance) therebetween. For example, in a transmission unit or a differential, meshing gearwheels may often have a play between them. This results in that the gearwheels sometimes may be out of contact with each other, whereby no torque is transmitted from the power source(s) to the one or more drive wheels of the vehicle. The phenomenon that occurs when no torque is transmitted through the driveline due to play between interacting constituent components thereof is known as backlash. The different plays that may be present in a driveline are additive which means that the rotation required by a power source to take up all of the plays within the driveline before turning of the drive wheels may be relatively large.

Backlash can for example occur when reversing direction of travel of the vehicle, during slow speed maneuvering, when going from freewheeling to a positive or negative torque transmitted from the power source through the driveline to the drive wheel(s), or when changing torque direction of the power source to change from deceleration to acceleration, or vice versa, of the vehicle.

Backlash can cause comfort issues when applying positive or negative torque from the torque-less state, often by causing a jolting vibration which may both be felt and heard by e.g. a driver of the vehicle. Backlash can also cause oscillations in the driveline of the powertrain, which may result both in reduced comfort and increased wear of constituent components of the driveline. Moreover, rattle and noise may occur, especially in a transmission unit of the driveline, as a result of backlash.

It is commonly known to reduce the problem of backlash by limiting the torque ramp-up when going from a torque-less state to a positive or negative torque transferred via the driveline, thereby slowing down the torque build-up in the driveline. This may however be perceived by e.g. a driver as a delayed response from the vehicle, and can therefore be seen as disturbing.

WO 2019/070179 A1 discloses a method intended to control backlash of a drivetrain (i.e., a driveline) included in a vehicle without having to limit the torque ramp-up. Said vehicle comprises one or more power sources including at least one electrical machine, and a drivetrain for transferring torque between the one or more power sources and at least one drive wheel of the vehicle. The method comprises, when no positive drive torque is transferred from the drivetrain to the at least one drive wheel, controlling the at least one electrical machine to provide a backlash torque to the drivetrain, the backlash torque having a controlled value for turning the drivetrain if there is a backlash in the drivetrain.

### SUMMARY

The object of the present invention is to find an alternative solution for reducing backlash in a vehicle.

The object is achieved by the subject-matter of the appended independent claim(s).

The present disclosure provides a method, performed by a control arrangement, for reducing backlash in a vehicle. Said vehicle comprises a first powertrain configured to provide propulsion torque to one or more first drive wheels of the vehicle, and a second powertrain configured to provide propulsion torque to one or more second drive wheels of the vehicle, wherein the first and second powertrains are mechanically separated from each other. The method comprises a step of, when a requested net torque for the vehicle is within the deliverable torque of one of the first powertrain and the second powertrain, controlling the first powertrain to deliver a first torque to said one or more first drive wheels and the second powertrain to deliver a second torque to said one or more second drive wheels, wherein the first torque and the second torque have opposite torque directions.

As mentioned above, the vehicle comprises a first powertrain and a second powertrain, the second powertrain being mechanically separated from the first powertrain. This means that backlash may occur in any one of the first and second powertrains. However, by means of the herein described method, it is ensured that none of the first and second powertrains is held in a torque-less state but instead exerts a force on the other one of the first and second powertrains. This in turn leads to turning of the drivelines of the respective powertrains, which removes the backlash in each of said driveline. Furthermore, this is achieved regardless of whether the net requested torque for the vehicle is zero, positive, or negative, which in turn means that the method may be performed for a large variety of operational conditions for the vehicle. Thereby, backlash disturbances may be eliminated as long as the net requested torque remains within one of the first and second powertrains' deliverable torque. This in turn contributes to improved driver comfort and reduced risk for driveline oscillations related to backlash. Moreover, by not having the torques delivered by the first and second powertrains, respectively, directed in the same torque direction, it is possible to avoid having to pass through the gaps of each of the powertrains when the requested net torque changes torque direction as long as the requested net torque is within the deliverable torque of one of the first and second powertrains.

Moreover, by means of the herein described method, there is no need for e.g. limiting the torque ramp-up when the net requested torque is increased from zero, or closed to zero, since no backlash needs to be taken care of in one of the first and second powertrains. Thereby, the initial feedback at torque request is considerably improved compared to conventional solutions for addressing backlash. This contributes to improved driver experience.

The method may further comprise controlling the first and second powertrains to maintain the first torque and the second torque, respectively, until a request for increased (positive or negative) net torque for the vehicle has been detected. This further ensures that the powertrain that is not currently providing the torque necessary to achieve the requested net torque of the vehicle will not again be subjected to backlash.

The method may further comprise a step of, in response to a request for change of torque direction of the net torque for the vehicle, adjusting the values of the first torque and second torque to meet the requested change in net torque for the vehicle without changing torque direction of the first and second torques, respectively. This is possible as long as the requested net torque is within the deliverable torque of one of the first powertrain and the second powertrain. By simply adjusting the values of the first and second torques, without changing the torque directions thereof, none of the first and second powertrains need to pass through the gaps generating backlash.

Each of the first torque and the second torque may suitably have a value being equal to or greater than both a predetermined backlash torque for the first powertrain and a predetermined backlash torque for the second powertrain, wherein each of the first and second predetermined backlash torques corresponds to a torque needed to turn a driveline of the relevant powertrain to remove backlash if altering rotational direction within said driveline. The first and second powertrains may have different configurations and thereby different backlash torques. By ensuring that the first and second torques delivered by the powertrains is at least equal to highest backlash torque of the respective powertrains, it is ensured that the backlash in each of the powertrains is eliminated even when the requested net torque for the vehicle is zero.

The value of the one of the first and second torques having a torque direction opposite to the torque direction of the requested net torque may suitably be less than 30 Nm. Thereby, it may be avoided that the energy consumption of the vehicle is unduly increased as a result of the herein described method.

As previously mentioned, the herein described method is performed when the requested net torque for the vehicle is within the deliverable torque of one of the first powertrain and the second powertrain. One example of such a situation is when the requested net torque for the vehicle is zero. Thus, according to one aspect, the method may be performed when the requested net torque for the vehicle is zero. In such a case, the sum of the first torque and the second torque may be zero. Thereby, the backlash in both the first and the second powertrains will be eliminated, which reduces the risk for noise and rattle from e.g. the transmission units of the first and second powertrains. Moreover, when the requested net torque for the vehicle is increased (regardless of whether it is to a positive or negative net torque), only the backlash from the powertrain that is applying torque in the opposite direction to the increased net torque for the vehicle will risk causing comfort issues since the backlash from the other powertrain is already eliminated.

The herein described method may for example be used while the vehicle is in motion or in conjunction with alternation of direction of travel of the vehicle. Thus, the herein described method may for example be performed when stopping freewheeling of one or more vehicle units of the vehicle, during maneuvering, when driving in traffic jam situations, during “snow plough turning”, or the like.

The vehicle may constitute a vehicle combination comprising at least a first vehicle unit and a second vehicle unit. In such a case, the first powertrain may be arranged in the first vehicle unit, and the second powertrain may be arranged in the second vehicle unit. Thereby, it is possible to reduce backlash in both a leading vehicle and a trailing vehicle of a vehicle combination.

The present disclosure further relates to a computer program comprising instructions which, when executed by a computer, cause the computer to carry out the method as described above.

The present disclosure further relates to a computer-readable medium comprising instructions which, when executed by a computer, cause the computer to carry out the method as described above.

Furthermore, a control arrangement configured to reduce backlash in a vehicle is provided. Said vehicle comprises a first powertrain configured to provide propulsion torque to one or more first drive wheels of the vehicle, and a second powertrain configured to provide propulsion torque to one or more second drive wheels of the vehicle. The first and second powertrains are mechanically separated from each other. The control arrangement is configured to, when a requested net torque for the vehicle is within the deliverable torque of one of the first powertrain and the second powertrain, control the first powertrain to deliver a first torque to said one or more first drive wheels and the second powertrain to deliver a second torque to said one or more second drive wheels, the first torque and the second torque having opposite torque directions.

The control arrangement provides the same advantages as described above with reference to the corresponding method for reducing backlash in a vehicle.

The control arrangement may further be configured to maintain the first torque from the first powertrain and the second torque from the second powertrain until a request for increased net torque for the vehicle has been detected.

The present disclosure also relates to a vehicle comprising the control arrangement as described above. The vehicle may comprise a first powertrain and a second powertrain that are mechanically separated from each other.

The vehicle may be a land-based vehicle comprising a single vehicle unit, or be a land-based vehicle combination comprising at least two vehicle units. The vehicle may for example be a heavy vehicle. Moreover, each vehicle unit of the vehicle may be a pure electric vehicle unit or a hybrid vehicle unit. The vehicle may also comprise a vehicle unit driven by a combustion engine as long as there is also a vehicle unit selected from a pure electric vehicle unit or a hybrid vehicle unit. Furthermore, the vehicle may be a vehicle configured to a driven fully or in part by a driver. Such a driver may be present onboard the vehicle or be remote from the vehicle, such as at a control center or the like.

Alternatively, the vehicle may be a fully autonomous vehicle.

### BRIEF DESCRIPTION OF DRAWINGS

FIG. 1 illustrates a side view of a first example of a vehicle,

FIG. 2 illustrates a side view of a second example of a vehicle,

FIG. 3 schematically illustrates an exemplifying embodiment of a vehicle comprising a first and a second powertrain,

FIG. 4 represents a flowchart schematically illustrating one exemplifying embodiment of the herein described method for reducing backlash in a vehicle,

FIG. 5 schematically illustrates an example of torque provided by the first and second powertrains of the vehicle over time, as a result of the herein described method for reducing backlash, when the requested net torque for the vehicle is changed from a positive net torque to a negative net torque,

FIG. 6 schematically illustrates another example of torque provided by the first and second powertrains of the vehicle over time, as a result of the herein described method for reducing backlash, when the requested net torque for the vehicle is changed from a positive torque to a negative torque and thereafter to a positive torque again,

FIG. 7 schematically illustrates an exemplifying embodiment of a device which may comprise, consist of, or be comprised in a control arrangement configured to perform the herein described method.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

A vehicle is in the present disclosure considered to mean any means that may be used for transporting people and/or cargo. A vehicle may consist of a single vehicle unit. Examples of a vehicle consisting of a single vehicle unit includes a car, a rigid truck, a tractor truck, a bus, a self-powered trailer, or a self-powered dolly, but are not limited thereto. Alternatively, a vehicle may constitute a vehicle combination comprising at least two vehicle units which are linked together when travelling. A vehicle combination may be a vehicle comprising a tractor vehicle and at least one trailing vehicle. Examples of vehicle combinations include a semi-trailer truck, a rigid truck pulling a semitrailer using a dolly, or a vehicle train comprising a rigid truck and one or more trailers, but is not limited thereto.

A vehicle powertrain comprises at least one power source (also known as a propulsion unit) and a driveline configured to transmit propulsion/braking torque to at least one drive vehicle of the vehicle. The driveline typically comprise at least one transmission unit, which e.g., may be a single reduction gear/single speed transmission unit or a multispeed transmission unit. The driveline may further comprise one or more shafts, for example a drive shaft. The driveline may also comprise other types of components, such as one or more joint devices (e.g. universal joints or constant velocity joints), a clutch, a differential etc.

In the present disclosure, two or more powertrains are considered to be mechanically separated from each other when there is no possibility for directly transmitting torque between said powertrains and the powertrains are connected to different drive wheel(s) of the vehicle. In other words, two powertrains are mechanically separated when a power source of one of the powertrains cannot transmit torque to the drive wheel(s) of the other powertrain and vice versa.

The efforts to increase electrification within the automotive industry has led to an increase of the number and types of vehicles that comprise a plurality of powertrains that are mechanically separated from each other. For example, heavy vehicles may be equipped with a first powertrain configured to provide propulsion torque to a first set of drive wheels of the vehicle and a second powertrain configured to provide propulsion torque to a second set of drive wheels of the vehicle, wherein at least one of the first and second powertrains constitutes an electric powertrain (for example an electric drive axle arrangement). Another example of a vehicle comprising two mechanically separated powertrains is a vehicle combination comprising a tractor vehicle comprising a first powertrain and at least one a trailing vehicle comprising a second powertrain. Such a trailing vehicle may for example be an electrified trailer (also known as an e-trailer). Furthermore, vehicles comprising a separate electrical motor for each drive wheel have been proposed. This may for example be achieved by usage of in-wheel motors (also known as wheel hub motors) that may be combined with a hub reduction (typically in the form of a planetary gear). The herein described method utilizes the fact that a vehicle comprises at least two mechanically separated powertrains for enabling to reduce, and in many cases eliminate, backlash.

More specifically, the present disclosure provides a method for reducing backlash in a vehicle that comprises at least two powertrains that are mechanically separated from each other. In other words, the vehicle comprises a first powertrain configured to provide propulsion torque to one or more first drive wheels of the vehicle. In case the first powertrain is configured to provide propulsion torque to more than a single first drive wheel of the vehicle, the first powertrain may alternatively be described as configured to provide propulsion torque to a first set of drive wheels. The vehicle further comprises a second powertrain configured to provide propulsion torque to one or more second drive wheels of the vehicle. In case the second powertrain is configured to provide propulsion torque to more than a single second drive wheel of the vehicle, the second powertrain may alternatively be described as configured to provide propulsion torque to a second set of drive wheels. The first and second powertrains may be comprised in the same vehicle unit, or may be comprised in different vehicle units of a vehicle combination.

The present method comprises a step of controlling the first powertrain to deliver a first torque to said one or more first drive wheels and simultaneous controlling the second powertrain to deliver a second torque to said one or more second drive wheels, said first and said second torques having opposite torque directions, thereby removing backlash in each of said first and second powertrains. In case each of the first and second powertrains are configured to provide propulsion torque to a respective set of drive wheels (as compared to a single drive wheel), said step may alternatively be described as controlling the first powertrain to deliver a first torque to the first set of drive wheels and simultaneously controlling the second powertrain to deliver a second torque to the second set of drive wheels, wherein the first torque and the second torque have opposite torque directions. Thereby, the first powertrain will generate a first force to the vehicle, whereas the second powertrain will generate a second force, in a direction opposite to the first force as seen in a primary moving direction of the vehicle, to the vehicle.

The method preferably also comprises controlling the first powertrain to maintain the first torque and the second powertrain to maintain the second torque, respectively, until a request for increased net torque (regardless of being positive or negative) has been detected. This ensures that backlashes in both powertrains remain eliminated. However, in some cases it may be acceptable to allow the powertrain which is not currently providing the torque necessary for meeting the requested net torque for the vehicle (except in case of the requested net torque being zero) to not exert any torque after the backlash in the other powertrain has been removed.

When the requested net torque for the vehicle changes in torque direction, the herein described method allows for meeting said change without having to pass the gaps of the first and second powertrains as long as the requested net torque remains within what is deliverable by one of the first and second powertrains. This is achieved by simply changing the values of the first and second torques, without altering their respective torque directions, to meet the change in requested net torque for the vehicle. In other words, the first and second powertrains are controlled so as to deliver torque to their respective drive wheel(s) which continues to be directed in the same opposing torque directions as prior to the change, but the values of the delivered torques of the first and second powertrains are altered to meet the requested net torque for the vehicle at any point in time. Thereby, none of the first and second powertrains will be subjected to backlash despite the change in torque direction of the requested net torque.

Each of the first torque and the second torque may suitably have a value being equal to or greater than both a predetermined backlash torque for the first powertrain and a predetermined backlash torque for the second powertrain, wherein each of the first and second predetermined backlash torques corresponds to a torque needed to turn a driveline of the relevant powertrain to remove backlash if altering rotational direction within said driveline. The first and second powertrains may have different configurations and thereby different backlash torques. By ensuring that the first and second torques delivered by the powertrains is at least equal to highest backlash torque of the respective powertrains, it is ensured that the backlash in each of the powertrains is eliminated even when the requested net torque for the vehicle is zero. The backlash torque for each powertrain may for example be determined in advance based on for example a model of each of the powertrains and/or historical data relating to the vehicle or other vehicles having the same vehicle specification. The backlash torque may alternatively be determined in advance based on experimental tests. According to yet another alternative, the backlash torque for each of the first and second powertrains may be determined through estimation thereof by the control arrangement configured to perform the method, for example in consideration of available data relating to the operation of the vehicle.

It should be noted that the value of the first and second torques discussed above may vary depending on the requested net torque for the vehicle. However, when the requested net torque for the vehicle is zero, the sum of the first torque and the second torque should preferably be essentially zero to ensure that a zero net torque for the vehicle is achieved.

The value of the torque provided by the one powertrain of the first and second powertrains which delivers a torque in an opposite direction to the requested net torque for the vehicle should preferably be kept sufficiently low to avoid unduly increasing the energy consumption of the vehicle (which in turn could unduly reduce the driving range obtainable by the energy stored onboard the vehicle, for example as fuel and/or electrical energy). Therefore, the value of the torque provided by the one powertrain of the first and second powertrains which delivers a torque in a torque direction opposite to the torque direction of the requested net torque may suitably be less than 30 Nm, preferably equal to or less than 20 Nm. Described differently, in case the first powertrain delivers the torque needed to achieve the requested net torque for the vehicle, the value of the second torque (which is delivered by the second powertrain) may suitably be less than 30 Nm or equal to or less than 20 Nm. Similarly, when the requested net torque is zero, the value of each of the first torque and the second torque may suitably be less than 30 Nm, preferably equal to or less than 20 Nm, in order not to unduly increase the energy losses.

It should be noted that the vehicle may comprise further powertrains, in addition to the first powertrain and the second powertrain. In such a case, the method may naturally comprise controlling all of the powertrains to reduce backlash through usage of torques with opposing directions. The control of torque direction (and torque value) provided by each powertrain will depend on the configuration of the vehicle as well as the requested net torque for the vehicle, but can easily be selected by the person skilled in the art based on the above description of the control of the first and second powertrains.

As previously mentioned, each of the powertrains may according to one alternative be configured to provide propulsion torque (and braking torque) to one single respective drive wheel, for example in case of each powertrain comprising a power source in the form of an in-wheel motor. The first and second powertrains may in such a case be associated with opposing drive wheels of the vehicle as seen in a transversal direction of the vehicle. As long as the torques provided by the first and second powertrains, respectively, are small, the resulting lateral torque on the vehicle may be acceptable. The resulting lateral torque on the vehicle may however be reduced/overcome if arranging two of the first powertrain and two of the second powertrain in a diagonal configuration in the vehicle, for example diagonally in a tandem drive arrangement, and controlling each of the two first and two second powertrains as already described above.

The herein described method may be performed while the vehicle is at standstill, such as when starting-up the vehicle, during loading/unloading of cargo, at a bus stop, at a traffic stop etc. However, the method may also be used while the vehicle is in motion as well as in conjunction with alternation of direction of travel of the vehicle. Thus, the herein described method may for example be performed when stopping freewheeling of one or more vehicle units of the vehicle, during maneuvering, when driving in traffic jam situations, during “snow plough turning”, or the like.

According to one alternative, the vehicle constitutes a vehicle combination comprising at least a first vehicle unit and a second vehicle unit. In such a case, the first powertrain may be arranged in the first vehicle unit, and the second powertrain may be arranged in the second vehicle unit. Thereby, it is possible to reduce backlash in both a leading vehicle and a trailing vehicle of a vehicle combination. The vehicle may however alternatively consist of a single vehicle unit, in which case the first powertrain and the second powertrain are comprised in said single vehicle unit. It should however be noted that it is possible that the first and second powertrains may be comprised in the same vehicle unit also in case of the vehicle constituting a vehicle combination.

The performance of the herein described method for reducing backlash in a vehicle may be governed by programmed instructions. These programmed instructions may take the form of a computer program which, when executed by a computer, cause the computer to effect desired forms of control action. Such a computer may for example be comprised in the control arrangement as described herein. A computer is in the present disclosure considered to mean any hardware or hardware/firmware device implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

The above described programmed instructions, which may take the form of a computer program, may be stored on a computer-readable medium. Hence, the present disclosure also relates to a computer-readable medium storing instructions, which when executed by computer, cause the computer to carry out the herein described method for reducing backlash a vehicle. The computer-readable medium may be a non-transitory computer-readable medium, such as a tangible electronic, magnetic, optical, infrared, electromagnetic, and/or semiconductor system, apparatus, and/or device.

The present disclosure further relates to a control arrangement configured to reduce backlash in a vehicle. The control arrangement may be configured to perform any one of the steps of the method for reducing backlash in a vehicle as described herein.

More specifically, in accordance with the present disclosure, a control arrangement configured to reduce backlash in a vehicle is provided. Said vehicle comprises a first powertrain configured to provide propulsion torque to one or more first drive wheels of the vehicle, and a second powertrain configured to provide propulsion torque to one or more second drive wheels of the vehicle, wherein the first and second powertrains are mechanically separated from each other. The control arrangement is configured to, when a requested net torque for the vehicle is within the deliverable torque of one of the first powertrain and the second powertrain, control the first powertrain to deliver a first torque to said one or more first drive wheels and control the second powertrain to simultaneously deliver a second torque to said one or more second drive wheels, the first torque and the second torque having opposite torque directions.

The control arrangement may comprise one or more control units. In case of the control arrangement comprising a plurality of control units, each control unit may be configured to control a certain function/step or a certain function/step may be divided between more than one control units. For example, a first control unit of the control arrangement may be configured to control the first powertrain of the vehicle and a second control unit of the control arrangement may be configured to control the second powertrain of the vehicle. The control arrangement may be a control arrangement of a powertrain management system of the vehicle. Alternatively, the control arrangement may be any other control arrangement of the vehicle but configured to communicate with the powertrain management system of the vehicle for the purpose of performing the herein described method.

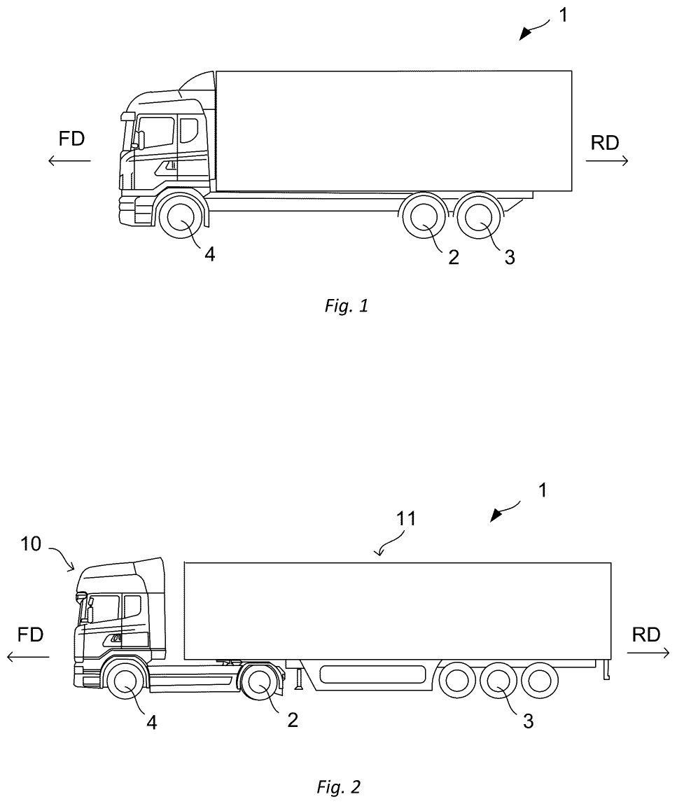

FIG. 1 illustrates a side view of a first example of a vehicle 1. The vehicle 1 is here illustrated as a rigid truck, and thus constitutes an example of a vehicle consisting of a single vehicle unit. A forward moving direction of the vehicle 1 is illustrated by the arrow FD, and a reversal moving direction is illustrated by the arrow RD in the figure.

The vehicle 1 comprises one or more first drive wheels 2 configured to be driven by a first powertrain (not shown) of the vehicle. In case of the vehicle 1 comprising a plurality of first drive wheels 2, these are typically evenly distributed on opposing sides of the vehicle 1, which is also the reason for only one first drive wheel 2 being visible in the figure.

The vehicle 1 further comprises one or more second drive wheels 3 configured to be driven by a second powertrain of the vehicle, said second powertrain being separate from the first powertrain. In case the vehicle 1 comprises a plurality of second drive wheels 3, these are typically evenly distributed on opposing sides of the vehicle 1.

The vehicle 1 further comprises front wheels 4. The front wheels may often be non-driven wheels but could alternatively be drive wheels, in which case they are driven by one or more powertrains of the vehicle.

FIG. 2 illustrates a side view of a second example of a vehicle 1. The vehicle 1 is here illustrated as a semi-trailer truck, and thus constitutes an example of a vehicle constituting a vehicle combination comprising two vehicle units. More specifically, the exemplified vehicle 1 comprises a first vehicle unit 10 in the form of a tractor vehicle (illustrated as a tractor truck) and a second vehicle unit 11 in the form of a trailing vehicle (herein illustrated as a semi-trailer).

Like the vehicle 1 shown in FIG. 1, the first vehicle unit 10 comprises one or more first drive wheels 2 configured to be driven by a first powertrain of the vehicle. The first powertrain of the vehicle 1 thus constitutes a powertrain of the first vehicle unit 10. The first vehicle unit further comprises front wheels 4, which may be non-driven wheels or drive wheels.

The vehicle further comprises one or more second drive wheels 3 configured to be driven by a second powertrain of the vehicle. In this case, the one or more second drive wheels 3 are part of the second vehicle unit 11. Thus, the second powertrain constitutes a powertrain of the second vehicle unit 11.

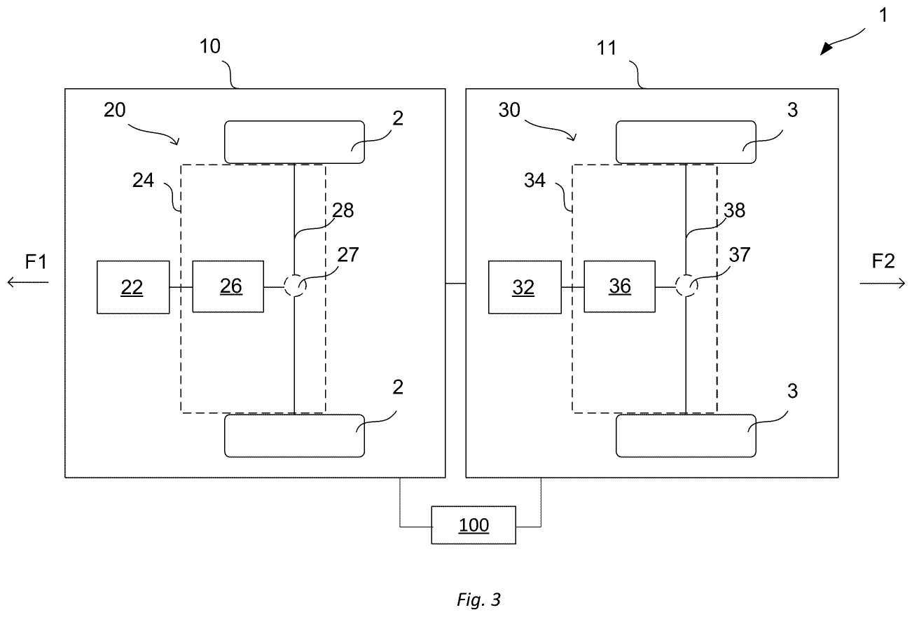

FIG. 3 schematically illustrates an exemplifying embodiment of a vehicle 1 comprising a first powertrain 20 and a second powertrain 30 that are mechanically separated from each other. The vehicle 1 is in the figure shown as a vehicle combination comprising a first vehicle unit 10 and a second vehicle unit 11, and may thus for example correspond to the vehicle shown in FIG. 2.

As shown in the figure, the first powertrain 20 of the vehicle may be arranged in the first vehicle unit 10 whereas the second powertrain 30 may be arranged in the second vehicle unit 11 of the vehicle 1. It should however be noted that the first and second vehicle powertrains 20, 30 may alternatively be arranged in the same vehicle unit, for example in case the vehicle would consist of a single vehicle unit. Furthermore, any one of the vehicle units 10, 11 may comprise more powertrains than illustrated in the figure, if desired.

The first powertrain 20 comprises at least one first power source 22 configured to provide propulsion torque to a plurality of first drive wheels 2 via a first driveline 24. The at least one first power source 22 may further be configured to provide a braking torque to the drive wheels 2 via the driveline 24. The at least one first power source 22 may for example be an electrical machine or a combustion engine. The first driveline 24 comprises at least one first transmission unit 26 connected to, optionally via a first differential 27, a first drive shaft 28. The first drive shaft 28 is in turn connected to the first drive wheels 2. The first transmission unit 26 may for example be a multispeed transmission unit. The first drive shaft 28 and the first differential 27, if present, are comprised in the first driveline 24.

The second powertrain 30 comprises at least one second power source 32 configured to provide propulsion torque (or braking torque) to a plurality of second drive wheels 3 via a second driveline 34. The second power source 32 may for example be an electrical machine, but is not limited thereto. The second driveline 34 comprises at least one second transmission unit 36 connected to, optionally via a second differential 37, a second drive shaft 38. The second drive shaft 38 is in turn connected to the second drive wheels 3. The second transmission unit 36 may for example be a multispeed transmission unit. The second drive shaft 38 and the second differential 37, if present, are comprised in the second driveline 34.

The vehicle 1 may further comprise a control arrangement 100 configured to perform the herein described method for reducing backlash. The control arrangement 100 may be configured to control both the first powertrain 20 and the second powertrain 30 for the purpose of performing the method.

As previously mentioned, the herein described method comprises controlling the first and second powertrains 20, 30 to deliver torque in opposite torque directions in order to at least reduce backlash in one, or both, of the powertrains 20, 30 of the vehicle 1. The torques delivered by the drive wheels 2, 3 will thereby create forces in opposite directions of the vehicle, as shown by the arrows F1 and F2. Depending on the current driving situation, these forces F1, F2, may have the same value or one of the forces F1, F2 may have a greater value than the other. However, when the requested net torque is not zero, the torque supplied in the opposite direction to a current travelling direction (and hence also the force resulting therefrom) should preferably be small in order to not unduly increase the total energy consumption of the vehicle.

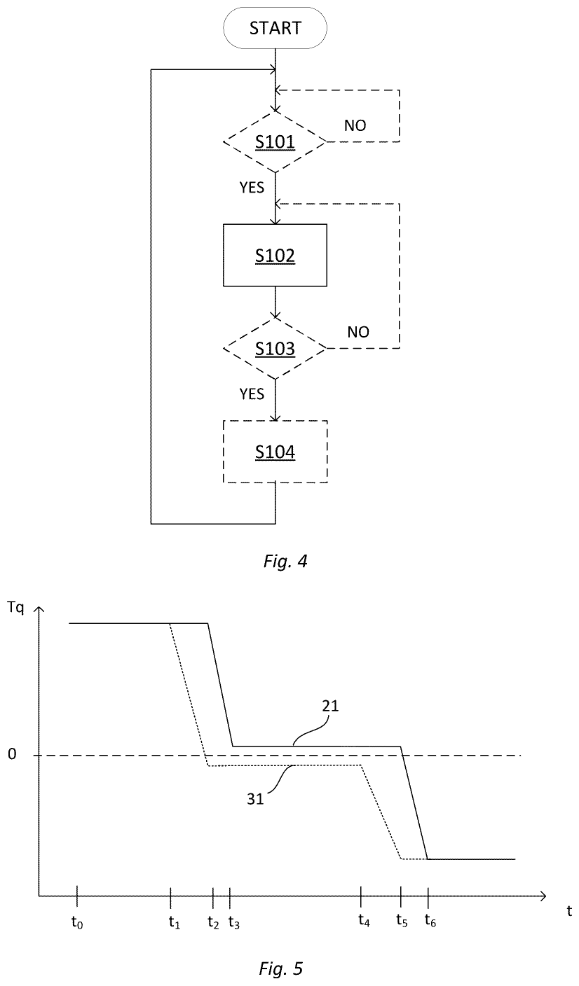

FIG. 4 represents a flowchart schematically illustrating a first exemplifying embodiment of the herein described method for reducing backlash in a vehicle. Optional steps are in the figure illustrated by dashed lines.

The method may comprise a step S101 of determining whether a requested net propulsion torque is within the deliverable torque of one of the first powertrain and the second powertrain. If the requested net propulsion torque is not within the deliverable torque of one of the first and second powertrains, the method may return to start.

The method further comprises a step S102 of, when the requested net propulsion torque is within the deliverable torque of one of the first powertrain and the second powertrain, controlling the first powertrain to deliver a first torque to said one or more first drive wheels and the second powertrain to deliver a second torque to said one or more second drive wheels, wherein the first torque and the second torque have opposite torque directions.

The method may further comprise a step S103 of determining whether there is a change in requested net torque for the vehicle. If not, the method may return to step S102, which in turn results in the first and second torques being maintained (both in terms of value and torque direction of the respective first and second torques). In case there is a change in requested net torque for the vehicle, the method may proceed to the optional subsequent step S104.

The method may comprise a step S104 of, in response to a request for change of torque direction of the net torque for the vehicle, adjusting the values of the first torque and second torque to meet the requested change in net torque for the vehicle without changing torque direction of the first and second torques, respectively. This is possible as long as the requested net torque, during the change thereof, remains within the deliverable torque of one of the first powertrain and the second powertrain.

Thereafter, the method may for example return to start.

FIG. 5 schematically illustrates an example of torque provided by the first and second powertrains of the vehicle over time as a result of the herein described method for reducing backlash, when the requested net torque for the vehicle is changed from a positive net torque to a negative net torque. The torque delivered by the first powertrain to the one or more first drive wheels is illustrated by the curve 21, whereas the torque delivered by the second powertrain to the one or more second drive wheels is illustrated by curve 31. According to the present example, the requested net torque for the vehicle at time t₀ requires both the first and the second powertrain to deliver a positive torque. In other words, the requested net torque for the vehicle is not within the deliverable torque of one of the first and second powertrains at to. Furthermore, the requested net torque for the vehicle after t₆ requires both the first and the second powertrain to deliver a negative torque and is thus not within the deliverable torque of one of the first and second powertrains.

When the net torque for the vehicle is to be changed from the initial positive torque to a negative torque, one of the powertrains may firstly be ramped down to a small negative torque. In the illustrated example, this is performed by ramping down the torque provided by the second powertrain between t₁ and t₂. Thereafter, the other powertrain (i.e. the first powertrain according to the example shown) may be ramped down to a small positive torque, which in the figure is shown to be performed between t₂ and t₃. As also shown in the figure, the duration t₂ to t₃ may be shorter than the duration t₁ and t₂.

When the net requested torque for the vehicle is about zero (and therefore within the deliverable torque of one of the first and second powertrains), i.e. between t₃ and t₄ in the figure, the first powertrain is controlled to deliver a small positive torque whereas the second powertrain is controlled to deliver a small negative torque. Thereby, there will be no backlash in any one of said first and second powertrains during said period of time and there is thus no risk for rattle and noise to be generated. When the requested net torque for the vehicle is changed to negative, only the backlash of the first powertrain has to be overcome since the backlash of the second powertrain was already eliminated prior to t₂.

The change from a zero net torque to a negative net torque may be performed by firstly ramping of the torque provided by the second powertrain, which already has the same torque direction as the net torque to be achieved. In the figure, this is shown to occur between t₄ and t₅. Thereafter, the torque delivered by the first powertrain may be ramped between t₅ and t₆.

Thus, it can be easily understood from this example that backlash disturbances are considerably reduced compared to if the powertrains had not been controlled to provide torque in opposite torque directions between t₃ and t₄ since they would otherwise be in a substantially torque-less state during said period of time, and there would likely be a considerable backlash disturbance at about t₂ when the requested net torque is changed to negative.

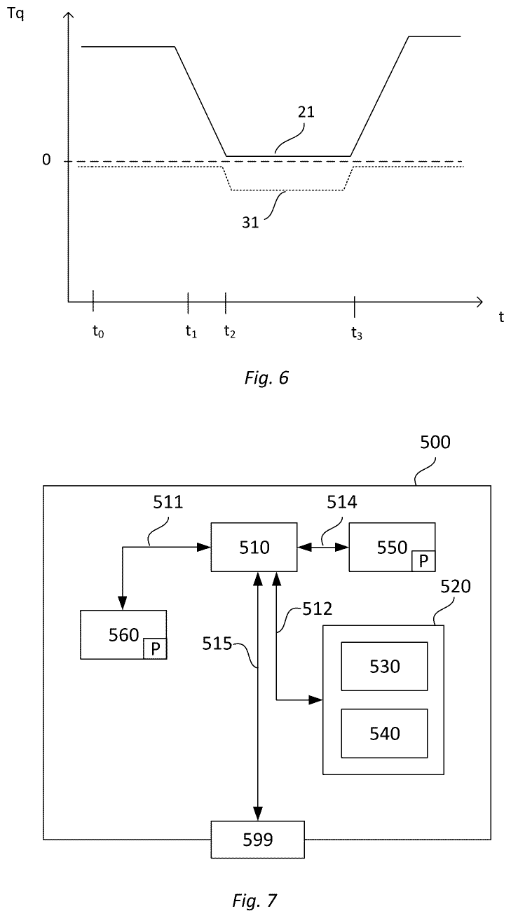

FIG. 6 schematically illustrates another example of torque provided by the first and second powertrains of the vehicle over time as a result of the herein described method for reducing backlash, here when the requested net torque for the vehicle is changed from a positive torque to a negative torque and thereafter to a positive net torque again. Also in this figure, the torque delivered by the first powertrain to the one or more first drive wheels is illustrated by the curve 21, and the torque delivered by the second powertrain to the one or more second drive wheels is illustrated by curve 31. However, according to this example, the requested net torque for the vehicle is within the deliverable torque of one of the powertrains, namely the first powertrain, for the whole period of time shown.

As can be seen from the figure, the first powertrain is controlled to provide a positive torque whereas the second powertrain is controlled to provide a small negative torque from time t₀ to about time t₁. Thereby, there will be no backlash in the second powertrain during this period of time, which would otherwise occur if it would be allowed to be in a torque-less state. The first powertrain is naturally not subjected to any backlash since it is controlled to deliver a positive torque sufficient to meet the requested net torque for the vehicle.

At t₁, the requested net torque for the vehicle is decreased and eventually changed to a negative net torque at about t₂ (which is to be maintained until about t₃). Therefore, the first powertrain is controlled to decrease the torque delivered therefrom between t₁ and t₂. However, the first powertrain is not controlled to decrease the torque delivered therefrom to zero, but to a small positive torque. Instead, the second powertrain, which was already controlled to provide a negative torque prior to t₂, is controlled to deliver a torque sufficient to meet the requested net torque for the vehicle. Thereby, there will be no risk for backlash disturbances in any one of the first and second powertrains since they each continue to provide a torque in the same direction as delivered between t₀ and t₁.

When the requested net torque for the vehicle is thereafter changed from a negative torque to a positive torque at about t₃, the first torque (delivered by the first powertrain) may be increased to meet the requested net torque, whereas the second torque (provided by the second powertrain) may be decreased to only a small negative torque. Again, there will be no backlash in any one of the first and second powertrains that needs to be overcome.

Thus, according to the example shown in FIG. 6, backlash in the vehicle may be fully eliminated for the whole duration shown. Should the requested net torque for the vehicle be increased beyond the deliverable torque of the first powertrain, only backlash in the second powertrain will occur when the torque delivered therefrom is changed from negative to positive.

FIG. 7 schematically illustrates an exemplifying embodiment of a device 500. The control arrangement 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises instructions for reducing backlash in a vehicle. Said vehicle comprises a first powertrain configured to provide propulsion torque to one or more first drive wheels of the vehicle, and a second powertrain configured to provide propulsion torque to one or more second drive wheels of the vehicle, wherein the first and second powertrains are mechanically separated from each other. The computer program comprises instructions for, when a requested net torque for the vehicle is within the deliverable torque of one of the first powertrain and the second powertrain, controlling the first powertrain to deliver a first torque to said one or more first drive wheels and the second powertrain to deliver a second torque to said one or more second drive wheels, wherein the first torque and the second torque have opposite torque directions.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

Parts of the methods herein described may be effected by the device 500 by means of the data processing unit 510 which runs the program stored in the memory 560 or the read/write memory 550. When the device 500 runs the program, methods herein described are executed.

1. A method, performed by a control arrangement, for reducing backlash in a vehicle, said vehicle comprising: a first powertrain configured to provide propulsion torque to one or more first drive wheels of the vehicle, and a second powertrain configured to provide propulsion torque to one or more second drive wheels of the vehicle, the first and second powertrains being mechanically separated from each other, the method comprising a step of:
when a requested net torque for the vehicle is within the deliverable torque of one of the first powertrain and the second powertrain, controlling the first powertrain to deliver a first torque to said one or more first drive wheels and the second powertrain to deliver a second torque to said one or more second drive wheels, the first torque and the second torque having opposite torque directions.

2. The method according to claim 1, further comprising controlling the first and second powertrains to maintain the first torque and the second torque, respectively, until a request for increased net torque for the vehicle has been detected.

3. The method according to claim 1, further comprising:
in response to a request for change of torque direction of the net torque for the vehicle, adjusting the values of the first torque and second torque to meet the requested change in net torque for the vehicle without changing torque direction of the first and second torques, respectively, when the requested net torque is within the deliverable torque of one of the first powertrain and the second powertrain.

4. The method according to claim 1, wherein
each of the first torque and the second torque has a value being equal to or greater than a predetermined backlash torque for the first powertrain and equal to or greater than a predetermined backlash torque for the second powertrain,
wherein each of the first and second predetermined backlash torques corresponds to a torque needed to turn a driveline of the relevant powertrain to remove backlash if altering rotational direction within said driveline.

5. The method according to claim 1, wherein the value of the one of the first and second torques having a torque direction opposite to the torque direction of the requested net torque is less than 30 Nm.

6. The method according to claim 1, wherein, when the requested net torque for the vehicle is zero, the sum of the first torque and the second torque is zero.

7. The method according to claim 1, wherein the method is performed while the vehicle is in motion, or in conjunction with alteration of direction of travel of the vehicle.

8. The method according to claim 1, wherein
the vehicle constitutes a vehicle combination comprising at least a first vehicle unit and a second vehicle unit, and
the first powertrain is arranged in the first vehicle unit, and
the second powertrain is arranged in the second vehicle unit.

9. A computer program product, stored on a non-transitory computer-readable medium, said computer program product for reducing backlash in a vehicle, said vehicle comprising: a first powertrain configured to provide propulsion torque to one or more first drive wheels of the vehicle, and a second powertrain configured to provide propulsion torque to one or more second drive wheels of the vehicle, the first and second powertrains being mechanically separated from each other, wherein said computer program product comprising computer instructions to cause one or more computing devices to perform the following operation:
when a requested net torque for the vehicle is within the deliverable torque of one of the first powertrain and the second powertrain, controlling the first powertrain to deliver a first torque to said one or more first drive wheels and the second powertrain to deliver a second torque to said one or more second drive wheels, the first torque and the second torque having opposite torque directions.

10. (canceled)

11. A control arrangement configured to reduce backlash in a vehicle,
said vehicle comprising: a first powertrain configured to provide propulsion torque to one or more first drive wheels of the vehicle, and a second powertrain configured to provide propulsion torque to one or more second drive wheels of the vehicle, the first and second powertrains being mechanically separated from each other,
wherein the control arrangement is configured to:
when a requested net torque for the vehicle is within the deliverable torque of one of the first powertrain and the second powertrain, control the first powertrain to deliver a first torque to said one or more first drive wheels and the second powertrain to deliver a second torque to said one or more second drive wheels, the first torque and the second torque having opposite torque directions.

12. The control arrangement according to claim 11, further configured to maintain the first torque from the first powertrain and the second torque from the second powertrain until a request for increased net torque for the vehicle has been detected.

13. A vehicle comprising:
a first powertrain configured to provide propulsion torque to one or more first drive wheels of the vehicle;
a second powertrain configured to provide propulsion torque to one or more second drive wheels of the vehicle, the first and second powertrains being mechanically separated from each other; and
a control arrangement configured to:
when a requested net torque for the vehicle is within the deliverable torque of one of the first powertrain and the second powertrain, control the first powertrain to deliver a first torque to said one or more first drive wheels and the second powertrain to deliver a second torque to said one or more second drive wheels, the first torque and the second torque having opposite torque directions.

14. The control arrangement according to claim 11, further configured to:
in response to a request for change of torque direction of the net torque for the vehicle, adjust the values of the first torque and second torque to meet the requested change in net torque for the vehicle without changing torque direction of the first and second torques, respectively, when the requested net torque is within the deliverable torque of one of the first powertrain and the second powertrain.

15. The control arrangement according to claim 11, wherein
each of the first torque and the second torque has a value being equal to or greater than a predetermined backlash torque for the first powertrain and equal to or greater than a predetermined backlash torque for the second powertrain,
wherein each of the first and second predetermined backlash torques corresponds to a torque needed to turn a driveline of the relevant powertrain to remove backlash if altering rotational direction within said driveline.

16. The control arrangement according to claim 11, wherein the value of the one of the first and second torques having a torque direction opposite to the torque direction of the requested net torque is less than 30 Nm.

17. The control arrangement according to claim 11, wherein, when the requested net torque for the vehicle is zero, the sum of the first torque and the second torque is zero.

18. The control arrangement according to claim 11, wherein the operations are performed while the vehicle is in motion, or in conjunction with alteration of direction of travel of the vehicle.

19. The control arrangement according to claim 11, wherein
the vehicle constitutes a vehicle combination comprising at least a first vehicle unit and a second vehicle unit, and
the first powertrain is arranged in the first vehicle unit, and
the second powertrain is arranged in the second vehicle unit.
